(19) United States
(12) Patent Application Publication
(10) Pub. No.: US 2025/0111410 A1
(43) Pub. Date: Apr. 3, 2025

(54) GENERATIVE ARTIFICIAL INTELLIGENCE-BASED LANDING PAGE VARIANTS FOR USER COHORTS OF AN ONLINE SYSTEM

(71) Applicant: Maplebear Inc., San Francisco, CA (US)

(72) Inventors: Van Nguyen, Brooklyn, NY (US); Fangzhou Wang, Oakland, CA (US); Ajay Pankaj Sampat, San Francisco, CA (US); Ann Barzman, San Francisco, CA (US); Yuan Gao, San Mateo, CA (US); Amsal Lakhani, Brooklyn, NY (US)

(21) Appl. No.: 18/374,462

(22) Filed: Sep. 28, 2023

(51) Int. Cl. G06Q 30/0241; G06F 40/197; G06Q 30/0204; G06Q 30/0242; G06Q 30/0251

(52) U.S. Cl. CPC G06Q 30/0276; G06F 40/197; G06Q 30/0204; G06Q 30/0243; G06Q 30/0255

(57) ABSTRACT

An online system receives user data for users of the online system and assigns the users to one or more user cohorts based on the user data. The online system generates a prompt for content to be included in a landing page presented to each user cohort, in which the prompt includes a template for the landing page and information describing the user cohorts. The online system then provides the prompt to a generative artificial intelligence model to obtain an output and extracts, from the output, a set of content to be included in the landing page for each user cohort. The online system generates variants of the landing page for each user cohort based on the extracted set of content.

### BACKGROUND

Online systems, such as online concierge systems, may allow users to sign up to access various services provided by the online systems. For example, an online concierge system may allow users to sign up to receive newsletters or promotions offered by the online concierge system, to create accounts that the users may use to place orders with the online concierge system, or to participate in a rewards program offered by the online concierge system. In the above example, the online concierge system also may allow users to sign up to become pickers who service orders placed by customers (e.g., by driving to retailer locations, collecting the orders, and delivering the orders to customers). Users may sign up to access these services via landing pages for the online systems. Since landing pages may include a wide variety of combinations of elements such as text (e.g., testimonials), images (e.g., photos), videos (e.g., tutorials), etc. in various arrangements, different landing pages may be more appealing, relevant, relatable, etc. to some users than others and online systems may therefore customize their landing pages to optimize user sign-ups. For example, since a user who is female and a vegetarian may be more inclined to sign up to become a picker for an online concierge system if a landing page for the online concierge system includes a first image of a female shopping for produce rather than a second image of a male shopping for meat, the landing page may be customized for the user by including the first image.

However, online systems may be unable to customize their landing pages to optimize user sign-ups for various reasons. For example, since users who have not signed up for services provided by an online system are often new users for which the online system has little or no information (e.g., demographic information, preferences, etc.), the online system may have difficulty determining the combinations and arrangements of elements to include in their landing page that are most likely to encourage the users to sign up for their services. In this example, it may take the online system a significant amount of time to test different versions of their landing page (e.g., via A/B testing) on each user to identify the combinations and arrangements of elements within the landing page that will optimize user sign-ups among the users. In the above example, while the different versions of the landing page are being tested, the online system may forego opportunities to obtain additional sign-ups by presenting their users with landing pages that are less likely to encourage the users to sign up for their services. As a result, failure to customize landing pages to optimize user sign-ups may negatively affect user retention among online systems.

### SUMMARY

In accordance with one or more aspects of the disclosure, an online system generates landing page variants for user cohorts based on outputs of a generative artificial intelligence model. More specifically, an online system receives user data for users of the online system and assigns the users to one or more user cohorts based on the user data. The online system generates a prompt for content to be included in a landing page presented to each user cohort, in which the prompt includes a template for the landing page and information describing the user cohort(s). The online system then provides the prompt to a generative artificial intelligence model to obtain an output and extracts, from the output, a set of content to be included in the landing page for each user cohort. The online system generates variants of the landing page for each user cohort based on the extracted set of content.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is a flowchart of a method for generating landing page variants for user cohorts of an online system based on outputs of a generative artificial intelligence model, in accordance with one or more embodiments.

FIG. 4 is an interaction diagram for generating landing page variants for user cohorts of an online system, in accordance with one or more embodiments.

FIGS. 5A-5C illustrate examples of landing page variants generated for user cohorts of an online system, in accordance with one or more embodiments.

FIG. 6 is an interaction diagram for selecting a landing page variant generated for a user cohort of an online system, in accordance with one or more embodiments.

### DETAILED DESCRIPTION

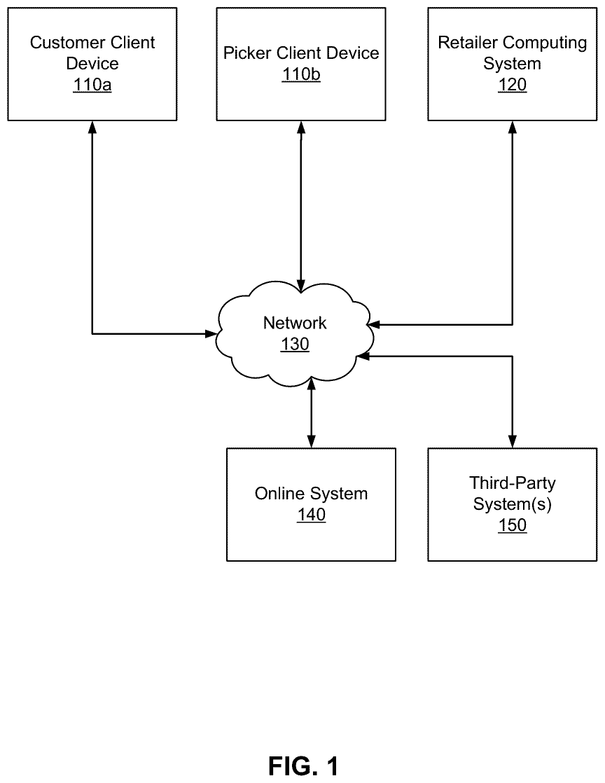

FIG. 1 illustrates an example system environment for an online system 140, such as an online concierge system, in accordance with one or more embodiments. The system environment illustrated in FIG. 1 includes a customer client device 110a, a picker client device 110b, a retailer computing system 120, a network 130, an online system 140, and one or more third-party systems 150. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 110a, picker client device 110b, and retailer computing system 120 are illustrated in FIG. 1, any number of customers, pickers, and retailers may interact with the online system 140. As such, there may be more than one customer client device 110a, picker client device 110b, or retailer computing system 120.

The customer client device 110a is a client device 110 through which a customer may interact with the picker client device 110b, the retailer computing system 120, the online system 140, or the third-party system(s) 150. The customer client device 110a can be a personal or mobile computing device, such as a smartphone, a tablet, a laptop computer, or a desktop computer. In some embodiments, the customer client device 110a executes a client application that uses an application programming interface (API) to communicate with the online system 140.

A customer uses the customer client device 110a to place an order with the online system 140. An order specifies a set of items to be delivered to the customer. An “item,” as used herein, refers to a good or product that may be provided to the customer through the online system 140. The order may include item identifiers (e.g., a stock keeping unit or a price look-up code) for items to be delivered to the customer and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 110a presents an ordering interface to the customer. The ordering interface is a user interface that the customer can use to place an order with the online system 140. The ordering interface may be part of a client application operating on the customer client device 110a. The ordering interface allows the customer to search for items that are available through the online system 140 and the customer can select which items to add to a “shopping list.” A “shopping list,” as used herein, is a tentative set of items that the customer has selected for an order but that has not yet been finalized for an order. The ordering interface allows a customer to update the shopping list, e.g., by changing the quantity of items, adding or removing items, or adding instructions for items that specify how the items should be collected.

The customer client device 110a may receive additional content from the online system 140 to present to a customer. For example, the customer client device 110a may receive coupons, recipes, or item suggestions. The customer client device 110a may present the received additional content to the customer as the customer uses the customer client device 110a to place an order (e.g., as part of the ordering interface).

Additionally, the customer client device 110a includes a communication interface that allows the customer to communicate with a picker that is servicing the customer's order. This communication interface allows the customer to input a text-based message to transmit to the picker client device 110b via the network 130. The picker client device 110b receives the message from the customer client device 110a and presents the message to the picker. The picker client device 110b also includes a communication interface that allows the picker to communicate with the customer. The picker client device 110b transmits a message provided by the picker to the customer client device 110a via the network 130. In some embodiments, messages sent between the customer client device 110a and the picker client device 110b are transmitted through the online system 140. In addition to text messages, the communication interfaces of the customer client device 110a and the picker client device 110b may allow the customer and the picker to communicate through audio or video communications, such as a phone call, a voice-over-IP call, or a video call.

The picker client device 110b is a client device 110 through which a picker may interact with the customer client device 110a, the retailer computing system 120, the online system 140, or the third-party system(s) 150. The picker client device 110b can be a personal or mobile computing device, such as a smartphone, a tablet, a laptop computer, or a desktop computer. In some embodiments, the picker client device 110b executes a client application that uses an application programming interface (API) to communicate with the online system 140.

The picker client device 110b receives orders from the online system 140 for the picker to service. A picker services an order by collecting the items listed in the order from a retailer location. The picker client device 110b presents the items that are included in the customer's order to the picker in a collection interface. The collection interface is a user interface that provides information to the picker identifying items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110b transmits to the online system 140 or the customer client device 110a which items the picker has collected in real time as the picker collects the items.

The picker can use the picker client device 110b to keep track of the items that the picker has collected to ensure that the picker collects all of the items for an order. The picker client device 110b may include a barcode scanner that can determine an item identifier encoded in a barcode coupled to an item. The picker client device 110b compares this item identifier to items in the order that the picker is servicing, and if the item identifier corresponds to an item in the order, the picker client device 110b identifies the item as collected. In some embodiments, rather than or in addition to using a barcode scanner, the picker client device 110b captures one or more images of the item and determines the item identifier for the item based on the images. The picker client device 110b may determine the item identifier directly or by transmitting the images to the online system 140. Furthermore, the picker client device 110b determines a weight for items that are priced by weight. The picker client device 110b may prompt the picker to manually input the weight of an item or may communicate with a weighing system in the retailer location to receive the weight of an item.

When the picker has collected all of the items for an order, the picker client device 110b provides instructions to a picker for delivering the items for a customer's order. For example, the picker client device 110b displays a delivery location from the order to the picker. The picker client device 110b also provides navigation instructions for the picker to travel from the retailer location to the delivery location. If a picker is servicing more than one order, the picker client device 110b identifies which items should be delivered to which delivery location. The picker client device 110b may provide navigation instructions from the retailer location to each of the delivery locations. The picker client device 110b may receive one or more delivery locations from the online system 140 and may provide the delivery locations to the picker so that the picker can deliver the corresponding one or more orders to those locations. The picker client device 110b may also provide navigation instructions for the picker from the retailer location from which the picker collected the items to the one or more delivery locations.

In some embodiments, the picker client device 110b tracks the location of the picker as the picker delivers orders to delivery locations. The picker client device 110b collects location data and transmits the location data to the online system 140. The online system 140 may transmit the location data to the customer client device 110a for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110b and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110b that they can use to interact with the online system 140. Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 may provide item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a customer's order (e.g., as a commission).

The customer client device 110a, the picker client device 110b, the retailer computing system 120, the online system 140, and the third-party system(s) 150 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

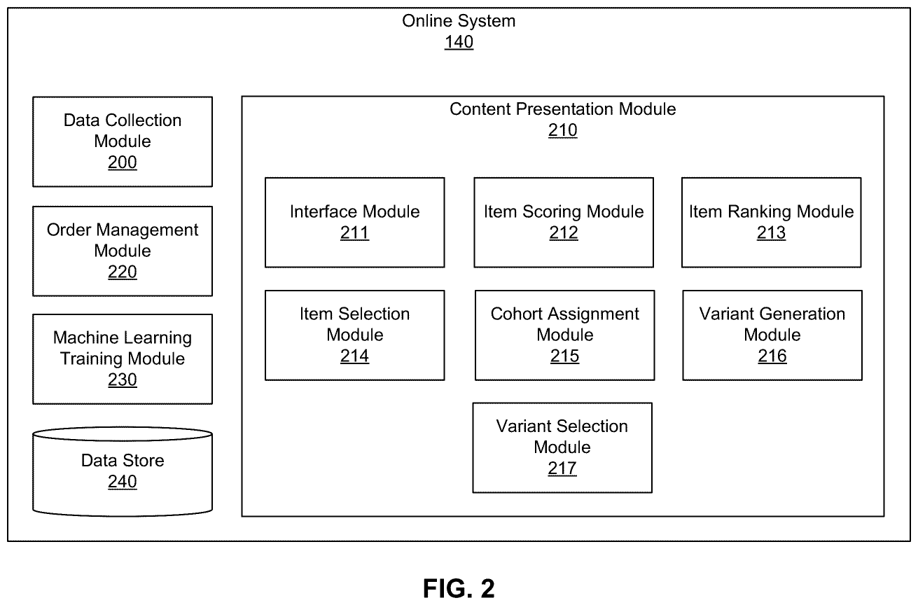

The online system 140 may be an online concierge system by which customers can order items to be provided to them by a picker from a retailer. The online system 140 receives orders from a customer client device 110a through the network 130. The online system 140 selects a picker to service the customer's order and transmits the order to a picker client device 110b associated with the picker. The picker collects the ordered items from a retailer location and delivers the ordered items to the customer. The online system 140 may charge a customer for the order and provide portions of the payment from the customer to the picker and the retailer. As an example, the online system 140 may allow a customer to order groceries from a grocery store retailer. The customer's order may specify which groceries they want delivered from the grocery store and the quantities of each of the groceries. The customer client device 110a transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110b by the online system 140. The online system 140 is described in further detail below with regards to FIG. 2.

One or more third-party systems 150 may provide user data to the online system 140. A third-party system 150 may be an analytics reporting system, an advertising system, a social networking system, or any other suitable type of system. User data provided to the online system 140 by the third-party system(s) 150 may describe user characteristics, user interactions (e.g., with one or more applications, websites, links, etc. provided by or maintained by the third-party system(s) 150), or any other suitable types of information. For example, a third-party system 150 may provide information to the online system 140 describing user interactions with various types of content via a set of social media integrations. As an additional example, a third-party system 150 that maintains a database of user interactions with a website (e.g., using cookies) or with content presented to users via emails (e.g., using tracking pixels) may provide information describing the user interactions to the online system 140. User data may be provided to the online system 140 by a third-party system 150 in association with various types of information (e.g., a timestamp indicating when it was provided or received by the third-party system 150, information identifying the third-party system 150, etc.). In some embodiments, a third-party system 150 uses an application programming interface (API) to communicate with the online system 140.

FIG. 2 illustrates an example system architecture for an online system 140, such as an online concierge system, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. The data collection module 200 may do so based on one or more consumer privacy laws, policies, etc. that may limit use or disclosure of personal information. Additionally, the online system 140 may only use some types of data describing a user collected by the data collection module 200 based on these consumer privacy law(s), policy/policies, etc. For example, the online system 140 may only use demographic information associated with a user to select content for presentation to the user if the user opts in to allowing the information to be used for this purpose. Additionally, the data collection module 200 may encrypt all data, including sensitive or personal data, describing users.

The data collection module 200 collects customer data, which is information or data describing characteristics of a customer. Customer data may include a customer's name, address, stored payment instruments, preferences/restrictions (e.g., dietary preferences or restrictions, shopping preferences, etc.), or interests (e.g., hobbies, favorite items, favorite retailers, etc.). The customer data also may include default settings established by a customer, such as a default retailer/retailer location, payment instrument, delivery location, or delivery timeframe. Customer data also may include demographic information associated with a customer. Examples of demographic information include: age, gender, ethnicity, income level, employment status, education level, occupation, relationship status, religion, geographical region (e.g., a city, state, or country that includes a customer's address or default delivery location), etc. In some embodiments, customer data also includes information indicating whether a customer has opted in to allowing some or all of their personal information to be used for various purposes (e.g., selecting content for presentation to the customer) with respect to one or more consumer privacy laws, policies, etc.

Customer data also may include historical interaction information associated with a customer. For example, customer data may include information describing previous orders placed by a customer with the online system 140 or information describing previous purchases made by the customer at retailer locations. As an additional example, customer data may include information describing previous interactions by a customer with items or other content (e.g., social media posts or advertisements) presented by the online system 140 or a third-party system 150. In the above example, the information may describe the items/content (e.g., item types, image or video content, etc.), the types of interactions (e.g., adding items to a shopping list, searching for items, clicking on an advertisement, commenting on a social media post, etc.), and the times of the interactions (e.g., a timestamp associated with each interaction). The data collection module 200 may collect the customer data from sensors on the customer client device 110a or based on a customer's interactions with the online system 140. The data collection module 200 also may collect customer data from other sources, such as a third-party system 150 (e.g., an advertising system, an analytics reporting system, or a social networking system) or a set of social media integrations.

In various embodiments, customer data also includes information that is derived from or predicted based on other customer data. For example, based on historical interaction information associated with a customer, customer data associated with the customer may include a frequency with which the customer orders an item, an interest of the customer in an item for which the customer searched, etc. As an additional example, based on a geographical region associated with a customer, customer data associated with the customer may include a population density associated with the customer, one or more retailer locations at which the customer is likely to shop, one or more types of cars the customer is likely to drive, etc. In some embodiments, the data collection module 200 uses a characteristic prediction model to predict characteristics of a customer. A characteristic prediction model is a machine learning model that is trained to predict one or more characteristics of a customer based on customer data for the customer. For example, the characteristic prediction model may be trained to predict a likelihood that a customer belongs to a particular age group. In some embodiments, customer data includes one or more user cohorts to which a customer is assigned by the cohort assignment module 215 based on other customer data for the customer, as described below. As used herein, a “user cohort” refers to one or more users that share one or more characteristics.

The data collection module 200 also collects item data, which is information or data that identifies and describes items that are available at a retailer location. The item data may include item identifiers for items that are available and may include quantities of items associated with each item identifier. Additionally, item data may also include attributes of items such as the sizes, colors, weights, stock keeping units (SKUs), serial numbers, prices, item categories, brands, qualities (e.g., freshness, ripeness, etc.), ingredients, materials, manufacturing locations, versions/varieties, or any other suitable attributes of the items. The item data may further include purchasing rules associated with each item, if they exist. For example, age-restricted items such as alcohol and tobacco are flagged accordingly in the item data. Item data may also include information that is useful for predicting the availability of items at retailer locations. For example, for each item-retailer combination (a particular item at a particular retailer location), the item data may include a time that the item was last found, a time that the item was last not found (a picker looked for the item but could not find it), the rate at which the item is found, or the popularity of the item. The data collection module 200 may collect item data from a retailer computing system 120, a picker client device 110b, or a customer client device 110a.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data describing characteristics of pickers. For example, the picker data for a picker may include the picker's name, the picker's location, how often the picker has serviced orders for the online system 140, a customer rating for the picker, the retailers from which the picker has collected items, or the picker's previous shopping history. Additionally, the picker data may include preferences expressed by the picker, such as their preferred retailers for collecting items, how far they are willing to travel to deliver items to a customer, how many items they are willing to collect at a time, timeframes within which the picker is willing to service orders, or payment information by which the picker is to be paid for servicing orders (e.g., a bank account). Picker data also may include a picker's interests (e.g., hobbies, favorite items, favorite retailers, etc.) or demographic information associated with a picker (e.g., age, gender, ethnicity, income level, employment status, education level, occupation, relationship status, religion, geographical region, etc.). In some embodiments, picker data also includes information indicating whether a picker has opted in to allowing some or all of their personal information to be used for various purposes (e.g., selecting content for presentation to the picker) with respect to one or more consumer privacy laws, policies, etc.

Picker data also may include historical interaction information associated with a picker. For example, picker data may include information describing previous interactions by a picker with items or other content (e.g., social media posts or advertisements) presented by the online system 140 or a third-party system 150. In the above example, the information may describe the items/content (e.g., item types, image or video content, etc.), the types of interactions (e.g., clicking on advertisements, expressing a preference for a social media post, etc.), and the times of the interactions (e.g., a timestamp associated with each interaction). The data collection module 200 collects picker data from sensors of the picker client device 110b or from the picker's interactions with the online system 140. The data collection module 200 also may collect the picker data from other sources, such as a third-party system 150 (e.g., an advertising system, an analytics reporting system, or a social networking system) or a set of social media integrations.

In various embodiments, picker data also includes information that is derived from or predicted based on other picker data. For example, based on historical interaction information associated with a picker, picker data associated with the picker may include a frequency with which the picker shops at a retailer location, an interest of the picker in an item tagged in an image for which the picker expressed a preference, etc. As an additional example, based on a geographical region associated with a picker, picker data associated with the picker may include a population density associated with the picker, one or more retailer locations at which the picker is likely to shop, one or more types of cars the picker is likely to drive, etc. The data collection module 200 may use the characteristic prediction model described above to predict characteristics of a picker based on picker data for the picker. For example, the characteristic prediction model may be trained to predict a likelihood that a picker has a particular hobby. In some embodiments, picker data also includes one or more user cohorts to which a picker is assigned by the cohort assignment module 215 based on other picker data for the picker, as described below.

Additionally, the data collection module 200 collects order data, which is information or data describing characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. Components of the content presentation module 210 include: an interface module 211, an item scoring module 212, an item ranking module 213, an item selection module 214, a cohort assignment module 215, a variant generation module 216, and a variant selection module 217, which are further described below.

The interface module 211 generates and transmits an ordering interface for a customer to order items. The interface module 211 populates the ordering interface with items that the customer may select for adding to their order. In some embodiments, the interface module 211 presents a catalog of all items that are available to the customer, which the customer can browse to select items to order. Other components of the content presentation module 210 may identify items that the customer is most likely to order and the interface module 211 may then present those items to the customer. For example, the item scoring module 212 may score items and the item ranking module 213 may rank the items based on their scores. In this example, the item selection module 214 may select items with scores that exceed some threshold (e.g., the top n items or the p percentile of items) and the interface module 211 then displays the selected items. The interface module 211 also may receive a request to access a landing page from a client device 110 (e.g., a customer client device 110a or a picker client device 110b) and transmit a variant of the landing page generated by the variant generation module 216 and selected by the variant selection module 217 to the client device 110, as further described below.

The item scoring module 212 may use an item selection model to score items for presentation to a customer. An item selection model is a machine learning model that is trained to score items for a customer based on item data for the items and customer data for the customer. For example, the item selection model may be trained to determine a likelihood that the customer will order an item. In some embodiments, the item selection model uses item embeddings describing items and customer embeddings describing customers to score items. These item embeddings and customer embeddings may be generated by separate machine learning models and may be stored in the data store 240.

In some embodiments, the item scoring module 212 scores items based on a search query received from the customer client device 110a. A search query is text for a word or set of words that indicate items of interest to the customer. The item scoring module 212 scores items based on a relatedness of the items to the search query. For example, the item scoring module 212 may apply natural language processing (NLP) techniques to the text in the search query to generate a search query representation (e.g., an embedding) that represents characteristics of the search query. The item scoring module 212 may use the search query representation to score candidate items for presentation to a customer (e.g., by comparing a search query embedding to an item embedding).

In some embodiments, the item scoring module 212 scores items based on a predicted availability of an item. The item scoring module 212 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The item scoring module 212 may weight the score for an item based on the predicted availability of the item. Alternatively, items may be filtered out from presentation to a customer based on whether the predicted availability of the item exceeds a threshold.

The cohort assignment module 215 assigns users to user cohorts. As described above, a user cohort refers to one or more users that share one or more characteristics. The cohort assignment module 215 may assign a user to one or more user cohorts based on user data for the user. For example, the cohort assignment module 215 may assign a user to a first user cohort including users who share a common geographical region and who are between the ages of 35 and 40. In this example, the cohort assignment module 215 also may assign the user to a second user cohort including users who share the common geographical region and/or to a third user cohort including users who are between the ages of 35 and 40. The user data that the cohort assignment module 215 uses to assign users to user cohorts may be received (e.g., by the data collection module 200 from one or more third-party systems 150) and/or retrieved (e.g., from customer data or picker data stored in the data store 240). The cohort assignment module 215 also may assign users to user cohorts based on a set of rules (e.g., one or more rules describing user characteristics that the cohort assignment module 215 may use to assign users to user cohorts, one or more rules indicating whether each user may be assigned to more than one user cohort, etc.). In some embodiments, the cohort assignment module 215 uses user embeddings describing users (e.g., customer embeddings describing customers or picker embeddings describing pickers) to assign users to user cohorts. These embeddings may be generated by one or more machine learning models and may be stored in the data store 240. For example, the cohort assignment module 215 may assign users to one or more user cohorts by grouping the users into one or more clusters using an unsupervised learning method (e.g., k-means clustering) based on an embedding representing each user, in which each cluster corresponds to a user cohort.

In some embodiments, user data (e.g., customer data or picker data) for a user may not be available or the user data may indicate that the user has not opted in to allowing some or all of their personal information to be used for various purposes (e.g., selecting content for presentation to the user) with respect to one or more consumer privacy laws, policies, etc. In embodiments in which user data for a user is not available or the user data indicates that the user has not opted in to allowing any of their personal information to be used for such purposes, the cohort assignment module 215 assigns the user to an anonymous user cohort. In embodiments in which user data for a user indicates that the user has opted in to allowing the use of only some of their personal information for such purposes, the cohort assignment module 215 may assign the user to a user cohort based only on this user data. For example, suppose that a user has opted in to allowing the online system 140 to use their age, gender, ethnicity, and geographical region to select content for presentation to the user, but has not opted in to allowing the online system 140 to use any other personal information for this purpose. In this example, the cohort assignment module 215 may assign the user to a user cohort based on their age, gender, ethnicity, and geographical region, but not based on other personal information associated with the user (e.g., religion, education level, income level, etc.).

In various embodiments, the cohort assignment module 215 determines information describing a user cohort. The cohort assignment module 215 may determine this information based on user data (e.g., customer data or picker data) associated with users assigned to the user cohort (e.g., a common age range, a shared interest, etc.). For example, if all users assigned to a user cohort include females between the ages of 18 and 25 who share a common favorite retailer and geographical region, the cohort assignment module 215 may determine information describing the user cohort corresponding to the female gender, the age range of 18 to 25, the name of the favorite retailer, and the name of the geographical region. Furthermore, in various embodiments, once the cohort assignment module 215 assigns a user to a user cohort, information describing the user cohort is stored in association with user data for the user in the data store 240. In embodiments in which the cohort assignment module 215 assigns one or more users to an anonymous user cohort, information describing the user cohort determined by the cohort assignment module 215 may indicate that the users are anonymous.

The variant generation module 216 may generate a prompt to a generative artificial intelligence (AI) model for content to be included in a landing page presented to one or more user cohorts. The prompt to the generative AI model may include various types of data (e.g., text data, image data, video data, or audio data). The generative AI model may be a large language model (e.g., ChatGPT) that generates a textual output based on a prompt, an image generator (e.g., DALL-E) that generates images from a prompt, or any other suitable type of generative AI model. In some embodiments, the generative AI model is trained by the machine learning training module 230. The landing page may be a sign-up page that allows users of the online system 140 to sign up for a service provided by the online system 140. For example, the landing page may be a sign-up page for a user to become a picker or for new or existing customers to receive newsletters or promotions offered by the online system 140. The landing page also or alternatively may be associated with one or more additional calls to action associated with the online system 140. For example, the landing page may be associated with a call to action to purchase or download an item, to install an application, to make a donation, to learn more about an item, etc.

A prompt generated by the variant generation module 216 may include a template for a landing page, information describing one or more user cohorts to which the landing page is to be presented, or any other suitable types of information. The template may include various elements, such as text (e.g., testimonials, information describing earnings information for pickers or benefits of creating a user account, etc.), images (e.g., photos or logos), videos (e.g., tutorials), audio (e.g., music or sound effects), interactive elements (e.g., buttons, scroll bars, etc.), placeholders (e.g., for text, images, or videos), display units (e.g., carousels, menus, etc.), or any other suitable elements. Furthermore, the template may describe an arrangement of the elements within the landing page (e.g., from top to bottom, from left to right, etc.). In some embodiments, the template is for a portion of the landing page. For example, the template may be for an element corresponding to a placeholder for an image to be included in the landing page. Information describing each user cohort included in the prompt may include user data (e.g., customer data or picker data) associated with users assigned to the user cohort, as described above.

To illustrate an example of a prompt generated by the variant generation module 216, suppose that a template included in the prompt includes a placeholder for an image of one or more people associated with a user cohort performing a shopping-related action. In this example, the prompt may include information describing the placeholder (e.g., image of {user cohort} performing {shopping-related} action) and information describing the user cohorts to which the landing page is to be presented (e.g., user cohort 1=women, user cohort 2=men, user cohort 3=couples). Alternatively, in the above example, the prompt may include information indicating that the placeholder is for an image of one or more people belonging to a user cohort shopping for a type of item at a particular retailer (e.g., image of {woman} shopping for {groceries} at {Retailer X}, image of {man} shopping for {vitamins} at {Retailer Y}, and image of {couple} shopping for {diapers} at {Retailer Z}).

Once the variant generation module 216 generates a prompt to a generative AI model for content to be included in a landing page presented to one or more user cohorts, the variant generation module 216 may provide the prompt to the generative AI model to obtain an output. The output of the generative AI model may include various types of data (e.g., text data, image data, video data, or audio data). For example, the variant generation module 216 may provide a prompt to the generative AI model including the template for the landing page and the information describing the user cohorts to which the landing page is to be presented in the above example. Continuing with this example, the variant generation module 216 may receive an output from the generative AI model including an image or a description of an image of a woman shopping for groceries at retailer X, an image or a description of an image of a man shopping for vitamins at Retailer Y, and an image or a description of an image of a couple shopping for diapers at Retailer Z.

The variant generation module 216 also extracts one or more sets of content from an output of a generative AI model, in which each set of content is to be included in a landing page for a user cohort. The variant generation module 216 may extract a set of content from the output using one or more techniques. For example, if the output of the generative AI model includes text, the variant generation module 216 may extract the set of content by applying one or more NLP techniques to the output. As an additional example, if the output of the generative AI model includes images or videos, the variant generation module 216 may extract the set of content using one or more computer vision techniques. In some embodiments, the variant generation module 216 may extract a set of content from the output of the generative AI model based on information included in a prompt provided to the generative AI model. For example, suppose that a prompt includes a template for a landing page and information describing multiple user cohorts, in which the template for the landing page includes a placeholder for an image of one or more people associated with a user cohort performing a shopping-related action and the information describing the user cohorts describes users of various age ranges. In this example, the variant generation module 216 may extract a set of content to be included in the landing page for each user cohort based on the information included in the prompt, such that for each user cohort, the variant generation module 216 extracts a set of content describing one or more people associated with a corresponding age range performing a shopping-related action.

The variant generation module 216 generates variants of a landing page for one or more user cohorts. The variant generation module 216 may generate the variants based on a set of content to be included in the landing page for each user cohort extracted from an output of a generative AI model. For example, suppose that a set of content to be included in a landing page for a user cohort extracted from an output of a generative AI model includes a first image of a person picking an item off a shelf, a second image of a person placing an item into a shopping basket, a third image of a person checking out at a retailer location, and a fourth image of a person delivering items to a customer. In the above example, the variant generation module 216 may generate four variants of the landing page for the user cohort, in which each variant of the landing page includes a different image extracted from the output of the generative AI model. In various embodiments, the variant generation module 216 generates variants of a landing page for a user cohort as variants of the landing page previously generated for the user cohort that do not perform well are discarded, as described below.

Variants of a landing page also may be generated by the variant generation module 216 based on additional types of information. Examples of such types of information include: a template for the landing page, a set of rules or guidelines associated with the landing page, a set of manually-generated content, or any other suitable types of information. For example, suppose that a template for a landing page includes elements such as text encouraging new users to become pickers, an interactive element corresponding to a button allowing users who click on the button to sign up to become pickers, and a placeholder for an image of one or more people performing a shopping-related action. In this example, suppose also that a first user cohort includes women, a second user cohort includes men, and a third user cohort includes couples. In the above example, all variants of the landing page may include the text and the button, but variants for the first user cohort may include different images of women performing shopping-related actions, variants for the second user cohort may include different images of men performing shopping-related actions, and variants for the third user cohort may include different images of couples performing shopping-related actions. As an additional example, each variant of a landing page may be generated by the variant generation module 216 based on a set of rules describing maximum or minimum dimensions of images or videos included in each variant, maximum or minimum font sizes of text included in each variant, maximum or minimum volume levels of audio included in each variant, etc. As yet another example, the variant generation module 216 may generate variants of a landing page for a user cohort that include a set of images that were manually generated for the user cohort.

Variants of a landing page generated by the variant generation module 216 also may be associated with various types of information. Examples of such types of information include: a call to action, one or more links from which the landing page may be accessed, or any other suitable types of information. For example, variants of a landing page may be associated with a call to action corresponding to signing up to become a picker, signing up to create an account that allows a customer to place orders with the online system 140, etc. As an additional example, variants of a landing page may be associated with an HTML button that acts as a link to the landing page. Once the variant generation module 216 generates variants of a landing page for a user cohort, each variant may be stored in the data store 240 in association with various types of information (e.g., information describing a user cohort for which the variant was generated, a time the variant was generated, a call to action associated with the variant, etc.).

The variant selection module 217 retrieves variants of a landing page generated for a user cohort to which a user was assigned and selects a variant to be displayed to the user. The variant selection module 217 may do so in response to receiving (via the interface module 211) a request from a client device 110 associated with the user to access the landing page. The variant selection module 217 may select the variant of the landing page using one or more techniques (e.g., A/B testing, a multi-armed bandit strategy, a roulette wheel selection method, etc.) to test each variant. For example, to conduct an A/B test, the variant selection module 217 may randomly select a variant of a landing page from multiple variants of the landing page generated for a user cohort, in which each variant differs with respect to an image included in the landing page. Alternatively, in the above example, the variant selection module 217 may select the variant using a multi-armed bandit strategy and a roulette wheel selection method, in which each variant of the landing page corresponds to an arm and arms that perform well are rewarded by being selected more frequently than arms that do not perform as well. In embodiments in which the cohort assignment module 215 assigns a user to an anonymous user cohort, the variant selection module 217 may retrieve a default variant of a landing page for display to the user, in which the default variant of the landing page was generated for the anonymous user cohort.

The variant selection module 217 also may track the performance of each variant of a landing page (e.g., based on a set of key performance indicators). For example, if the variant selection module 217 selects a variant of a landing page to be displayed to a user using a multi-armed bandit strategy, as described in the above example, the variant selection module 217 also may track the performance of the variant based on a conversion rate associated with the variant (e.g., a rate at which users presented with the variant sign up to become pickers). In this example, variants that do not perform well are eventually discarded while those that perform well may continue to be tested by ranking the variants based on the tracked set of key performance indicators, identifying a set of variants associated with at least a threshold ranking that may continue to be tested, and discarding a set of variants associated with less than the threshold ranking. Information describing the performance of each variant of a landing page may be stored in the data store 240.

Once the variant selection module 217 selects a variant of a landing page or the variant selection module 217 retrieves a default variant of the landing page for display to a user, the interface module 211 may send this variant for display to a client device 110 (e.g., a customer client device 110a or a picker client device 110b) associated with the user. For example, suppose that the interface module 211 receives a request to access a landing page from a client device 110 associated with a user of the online system 140. In this example, the request may be received when the user interacts with an advertisement presented to the user (e.g., via a third-party system 150), in which the advertisement is associated with a call to action corresponding to learning more about becoming a picker. Continuing with this example, once the variant selection module 217 retrieves variants of the landing page generated for a user cohort to which the user was assigned, in which the variants are associated with a call to action corresponding to becoming a picker, and selects a variant to be displayed to the user, the interface module 211 may send the variant for display to the client device 110 associated with the user.

The order management module 220 manages orders for items from customers. The order management module 220 receives orders from customer client devices 110a and assigns the orders to pickers for service based on picker data. For example, the order management module 220 assigns an order to a picker based on the picker's location and the retailer location from which the ordered items are to be collected. The order management module 220 may also assign an order to a picker based on how many items are in the order, a vehicle operated by the picker, the delivery location, the picker's preferences for how far to travel to deliver an order, the picker's ratings by customers, or how often a picker agrees to service an order.

In some embodiments, the order management module 220 determines when to assign an order to a picker based on a delivery timeframe requested by the customer who placed the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110b associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110b to determine when the picker arrives at the retailer location. When the picker arrives at the retailer location, the order management module 220 transmits the order to the picker client device 110b for display to the picker. As the picker uses the picker client device 110b to collect items at the retailer location, the order management module 220 receives item identifiers for items that the picker has collected for the order. In some embodiments, the order management module 220 receives images of items from the picker client device 110b and applies computer-vision techniques to the images to identify the items depicted by the images. The order management module 220 may track the progress of the picker as the picker collects items for an order and may transmit progress updates to the customer client device 110a that describe which items have been collected for the customer's order.

In some embodiments, the order management module 220 tracks the location of the picker within the retailer location. The order management module 220 uses sensor data from the picker client device 110b or from sensors in the retailer location to determine the location of the picker in the retailer location. The order management module 220 may transmit instructions to the picker client device 110b to display a map of the retailer location indicating where in the retailer location the picker is located. Additionally, the order management module 220 may instruct the picker client device 110b to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110b indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110b. The order management module 220 may also transmit navigation instructions to the picker client device 110b that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 110a and the picker client device 110b. As noted above, a customer may use a customer client device 110a to send a message to the picker client device 110b. The order management module 220 receives the message from the customer client device 110a and transmits the message to the picker client device 110b for presentation to the picker. The picker may use the picker client device 110b to send a message to the customer client device 110a in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online system 140. The online system 140 may use machine learning models to perform functionalities described herein. Example machine learning models include regression models, support vector machines, naïve bayes, decision trees, k-nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative AI models (e.g., generative adversarial networks, large language models, etc.), or transformers.

Each machine learning model includes a set of parameters. A set of parameters for a machine learning model is used by the machine learning model to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In situations in which the training example includes a label, the loss function is also based on the label for the training example. Some example loss functions include the mean square error function, the mean absolute error, the hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data, for use by the online system 140. As an additional example, the data store 240 may store variants of landing pages that may be presented to users of the online system 140, in which the variants of the landing pages are stored in association with information describing the user cohorts for which they were generated, the times at which they were generated, calls to action associated with the variants, etc. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

### Generating Landing Page Variants for User Cohorts of an Online System Based on Outputs of a Generative Artificial Intelligence Model

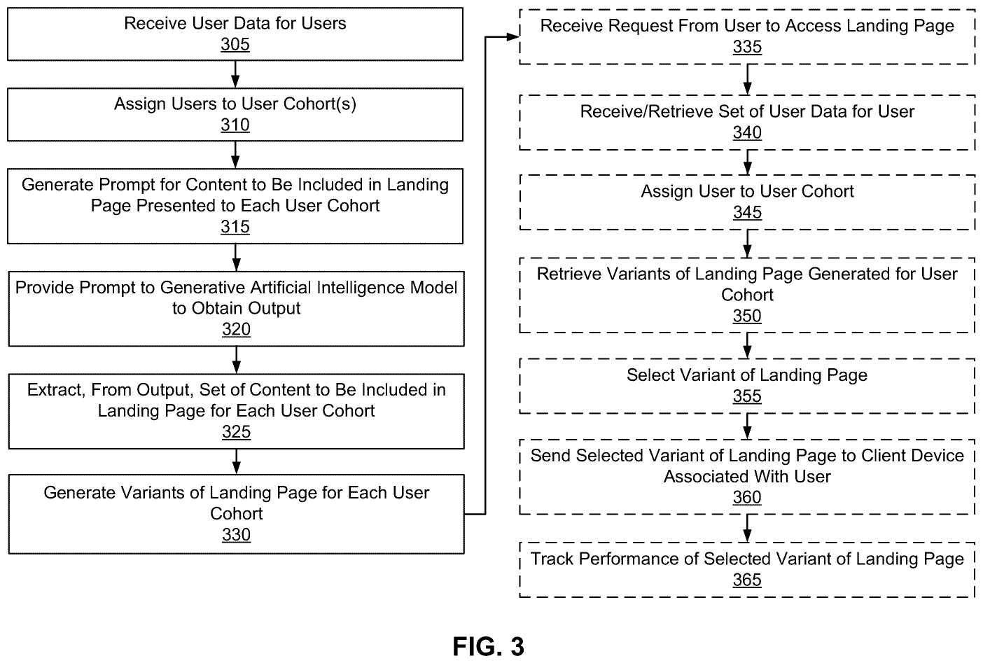

FIG. 3 is a flowchart of a method for generating landing page variants for user cohorts of an online system 140 based on outputs of a generative artificial intelligence model, in accordance with one or more embodiments. Alternative embodiments may include more, fewer, or different steps from those illustrated in FIG. 3, and the steps may be performed in a different order from that illustrated in FIG. 3. These steps may be performed by an online system (e.g., online system 140), such as an online concierge system. Additionally, each of these steps may be performed automatically by the online system 140 without human intervention.

The online system 140 receives 305 (e.g., via the data collection module 200) user data for users of the online system 140. The user data may be received 305 from one or more sensors on client devices 110 associated with the users, based on the users' interactions with the online system 140, from one or more third-party systems 150 (e.g., one or more advertising systems, analytics reporting systems, or social networking systems), or via a set of social media integrations. The user data may include a user's name, address, preferences/restrictions (e.g., dietary preferences or restrictions, shopping preferences, etc.), or interests (e.g., hobbies, favorite items, favorite retailers, etc.). The user data also may include demographic information associated with a user (e.g., age, gender, ethnicity, income level, employment status, education level, occupation, relationship status, religion, geographical region, etc.). The user data also may include historical interaction information, such as historical order/purchase information associated with a user or information describing previous interactions by a user with items or other content (e.g., social media posts or advertisements) presented by the online system 140 or a third-party system 150. In various embodiments, the user data also includes information that is derived from or predicted based on other user data (e.g., an interest of a user in an item for which the user searched, one or more retailer locations at which the user is likely to shop or one or more types of cars the user is likely to drive based on a geographical region associated with the user, etc.). In some embodiments, the user data also includes information indicating whether a user has opted in to allowing use of some or all of their personal information for various purposes (e.g., selecting content for presentation to the user) with respect to one or more consumer privacy laws, policies, etc. In some embodiments, the online system 140 stores the user data (e.g., among customer data or picker data in the data store 240).

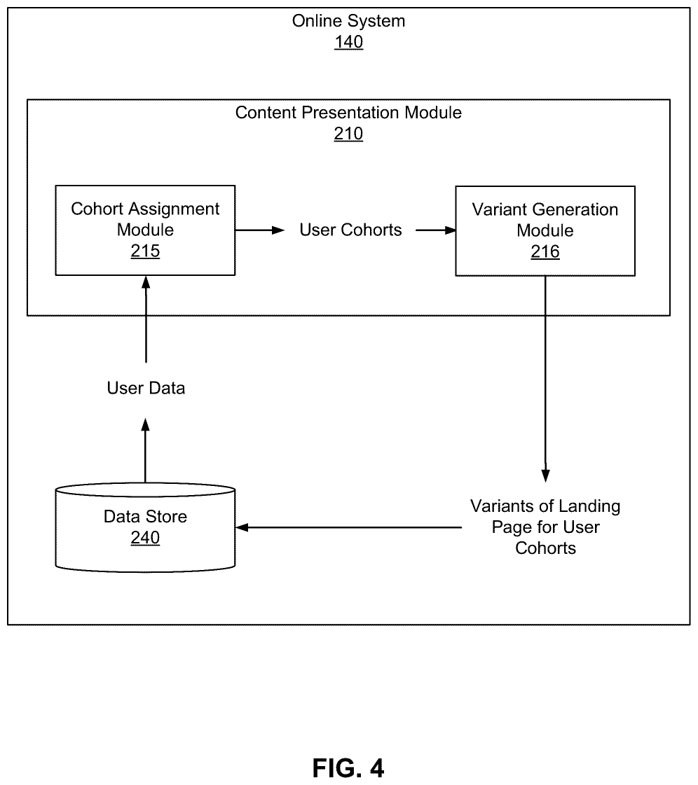

The online system 140 then assigns 310 (e.g., using the cohort assignment module 215) the users to one or more user cohorts based on the user data for the users. As described above, a user cohort refers to one or more users that share one or more characteristics. For example, the online system 140 may assign 310 a user to a first user cohort including users who share a common geographical region and who are between the ages of 35 and 40. In this example, the online system 140 also may assign 310 the user to a second user cohort including users who share the common geographical region and/or to a third user cohort including users who are between the ages of 35 and 40. In some embodiments, the online system 140 assigns 310 the users to the user cohort(s) based on information stored in the online system 140 (e.g., based on characteristics included among customer data or picker data stored in the data store 240) as shown in the example of FIG. 4, which is an interaction diagram for generating landing page variants for user cohorts of an online system 140, in accordance with one or more embodiments. The online system 140 also may assign 310 the users to the user cohort(s) based on a set of rules (e.g., one or more rules describing user characteristics that the online system 140 may use to assign 310 the users to the user cohort(s), one or more rules indicating whether each user may be assigned 310 to more than one user cohort, etc.). In some embodiments, the online system 140 uses user embeddings describing the users (e.g., customer embeddings describing customers or picker embeddings describing pickers) to assign 310 the users to the user cohort(s). These embeddings may be generated by one or more machine learning models and may be stored (e.g., in the data store 240). For example, the online system 140 may assign 310 the users to the user cohort(s) by grouping the users into one or more clusters using an unsupervised learning method (e.g., k-means clustering) based on an embedding representing each user, in which each cluster corresponds to a user cohort.

In some embodiments, user data (e.g., customer data or picker data) for a user may not be available or the user data may indicate that the user has not opted in to allowing some or all of their personal information to be used for various purposes (e.g., selecting content for presentation to the user) with respect to one or more consumer privacy laws, policies, etc. In embodiments in which user data for a user is not available or the user data indicates that the user has not opted in to allowing any of their personal information to be used for such purposes, the online system 140 assigns 310 the user to an anonymous user cohort. In embodiments in which user data for a user indicates that the user has opted in to allowing the use of only some of their personal information for such purposes, the online system 140 may assign 310 the user to a user cohort based only on this user data. For example, suppose that a user has opted in to allowing the online system 140 to use their age, gender, ethnicity, and geographical region to select content for presentation to the user, but has not opted in to allowing the online system 140 to use any other personal information for this purpose. In this example, the online system 140 may assign 310 the user to a user cohort based on their age, gender, ethnicity, and geographical region, but not based on other personal information associated with the user (e.g., religion, education level, income level, etc.).

In various embodiments, the online system 140 determines (e.g., using the cohort assignment module 215) information describing each user cohort. The online system 140 may determine this information based on the user data (e.g., customer data or picker data) associated with users assigned 310 to the user cohort (e.g., a common age range, a shared interest, etc.). For example, if all users assigned 310 to a user cohort include females between the ages of 18 and 25 who share a common favorite retailer and geographical region, the online system 140 may determine information describing the user cohort corresponding to the female gender, the age range of 18 to 25, the name of the favorite retailer, and the name of the geographical region. Furthermore, in various embodiments, once the online system 140 assigns 310 a user to a user cohort, information describing the user cohort is stored in association with user data for the user (e.g., in the data store 240). In embodiments in which the online system 140 assigns 310 one or more users to an anonymous user cohort, information describing the user cohort determined by the online system 140 may indicate that the users are anonymous.

Referring back to FIG. 3, the online system 140 then generates 315 (e.g., using the variant generation module 216) a prompt to a generative artificial intelligence (AI) model for content to be included in a landing page presented to the user cohort(s). The prompt to the generative AI model may include various types of data (e.g., text data, image data, video data, or audio data). The generative AI model may be a large language model (e.g., ChatGPT) that generates a textual output based on a prompt, an image generator (e.g., DALL-E) that generates images from a prompt, or any other suitable type of generative AI model. In some embodiments, the generative AI model is trained by the online system 140 (e.g., using the machine learning training module 230). The landing page may be a sign-up page that allows users of the online system 140 to sign up for a service provided by the online system 140. For example, the landing page may be a sign-up page for a user to become a picker or for new or existing customers to receive promotions offered by the online system 140. The landing page also or alternatively may be associated with one or more additional calls to action associated with the online system 140. For example, the landing page may be associated with a call to action to purchase or download an item, to install an application, to make a donation, to learn more about an item, etc.

The prompt generated 315 by the online system 140 may include a template for the landing page, information describing the user cohort(s) to which the landing page is to be presented, or any other suitable types of information. The template may include various elements, such as text (e.g., testimonials, information describing earnings information for pickers or benefits of creating a user account, etc.), images (e.g., photos or logos), videos (e.g., tutorials), audio (e.g., music or sound effects), interactive elements (e.g., buttons, scroll bars, etc.), placeholders (e.g., for text, images, or videos), display units (e.g., carousels, menus, etc.), or any other suitable elements. Furthermore, the template may describe an arrangement of the elements within the landing page (e.g., from top to bottom, from left to right, etc.). In some embodiments, the template is for a portion of the landing page. For example, the template may be for an element corresponding to a placeholder for an image to be included in the landing page. Information describing each user cohort included in the prompt may include user data (e.g., customer data or picker data) associated with users assigned 310 to the user cohort, as described above.

To illustrate an example of the prompt generated 315 by the online system 140, suppose that the template included in the prompt includes a placeholder for an image of one or more people associated with a user cohort performing a shopping-related action. In this example, the prompt may include information describing the placeholder (e.g., image of {user cohort} performing {shopping-related} action) and information describing the user cohorts to which the landing page is to be presented (e.g., user cohort 1=women, user cohort 2=men, user cohort 3=couples). Alternatively, in the above example, the prompt may include information indicating that the placeholder is for an image of one or more people belonging to a user cohort shopping for a type of item at a particular retailer (e.g., image of {woman} shopping for {groceries} at {Retailer X}, image of {man} shopping for {vitamins} at {Retailer Y}, and image of {couple} shopping for {diapers} at {Retailer Z}).

Once the online system 140 generates 315 the prompt to the generative AI model for content to be included in the landing page presented to the user cohort(s), the online system 140 may provide 320 (e.g., using the variant generation module 216) the prompt to the generative AI model to obtain an output. The output of the generative AI model may include various types of data (e.g., text data, image data, video data, or audio data). For example, the online system 140 may provide 320 a prompt to the generative AI model including the template for the landing page and the information describing the user cohorts to which the landing page is to be presented in the above example. Continuing with this example, the online system 140 may receive an output from the generative AI model including an image or a description of an image of a woman shopping for groceries at retailer X, an image or a description of an image of a man shopping for vitamins at Retailer Y, and an image or a description of an image of a couple shopping for diapers at Retailer Z.

The online system 140 then extracts 325 (e.g., using the variant generation module 216), from the output of the generative AI model, one or more sets of content, in which each set of content is to be included in the landing page for a cohort of the one or more user cohorts. The online system 140 may extract 325 a set of content from the output using one or more techniques. For example, if the output of the generative AI model includes text, the online system 140 may extract 325 the set of content by applying one or more NLP techniques to the output. As an additional example, if the output of the generative AI model includes images or videos, the online system 140 may extract 325 the set of content using one or more computer vision techniques. In some embodiments, the online system 140 may extract 325 a set of content from the output of the generative AI model based on information included in the prompt provided 320 to the generative AI model. For example, suppose that the prompt includes the template for the landing page and information describing multiple user cohorts, in which the template for the landing page includes a placeholder for an image of one or more people associated with a user cohort performing a shopping-related action and the information describing the user cohorts describes users of various age ranges. In this example, the online system 140 may extract 325 a set of content to be included in the landing page for each user cohort based on the information included in the prompt, such that for each user cohort, the online system 140 extracts 325 a set of content describing one or more people associated with a corresponding age range performing a shopping-related action.

The online system 140 generates (step 330, e.g., using the variant generation module 216) variants of the landing page for the user cohort(s), as shown in FIG. 4. The online system 140 may generate 330 the variants based on the set of content to be included in the landing page for each user cohort extracted 325 from the output of the generative AI model. For example, suppose that a set of content to be included in the landing page for a user cohort extracted 325 from the output of the generative AI model includes a first image of a person picking an item off a shelf, a second image of a person placing an item into a shopping basket, a third image of a person checking out at a retailer location, and a fourth image of a person delivering items to a customer. In the above example, the online system 140 may generate 330 four variants of the landing page for the user cohort, in which each variant of the landing page includes a different image extracted 325 from the output of the generative AI model. In various embodiments, the online system 140 generates (step 330) variants of the landing page for a user cohort as variants of the landing page previously generated 330 for the user cohort that do not perform well are discarded, as described below.

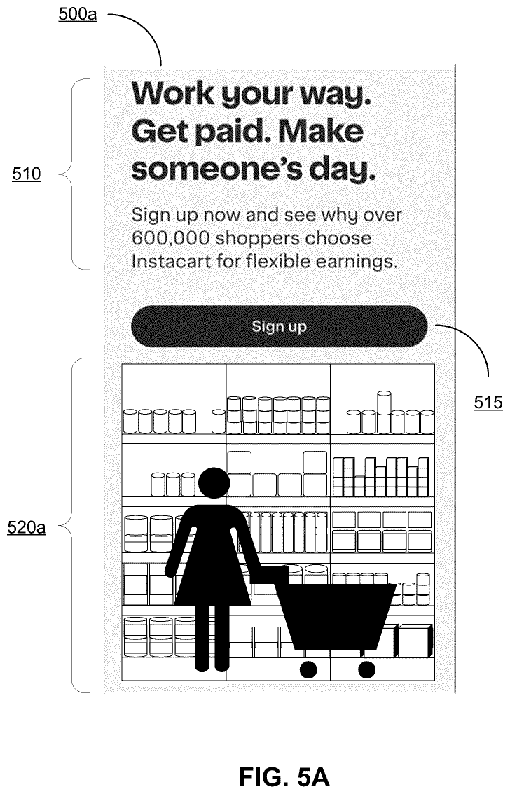

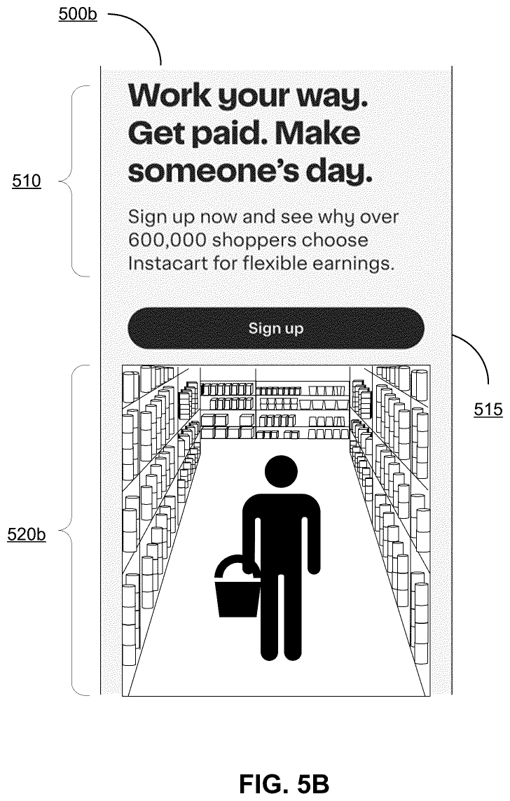

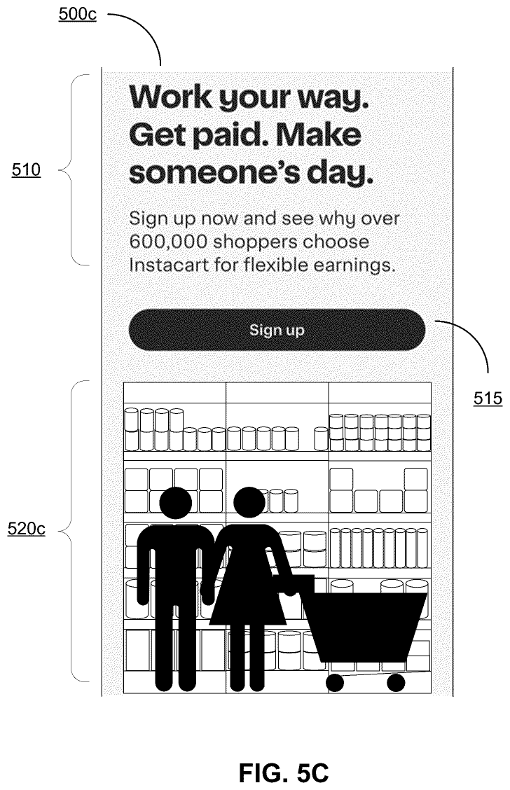

Variants of the landing page also may be generated 330 by the online system 140 based on additional types of information. Examples of such types of information include: the template for the landing page, a set of rules or guidelines associated with the landing page, a set of manually-generated content, or any other suitable types of information. For example, suppose that the template for the landing page includes elements such as text encouraging new users to become pickers, an interactive element corresponding to a button allowing users who click on the button to sign up to become pickers, and a placeholder for an image of one or more people performing a shopping-related action. In this example, suppose also that a first user cohort includes women, a second user cohort includes men, and a third user cohort includes couples. As shown in FIGS. 5A-5C, which illustrate examples of landing page variants 500 generated 330 for user cohorts of an online system 140, in accordance with one or more embodiments, all variants 500 of the landing page may include the text 510 and the button 515, but variants 500a for the first user cohort may include different images 520a of women performing shopping-related actions, variants 500b for the second user cohort may include different images 520b of men performing shopping-related actions, and variants 500c for the third user cohort may include different images 520c of couples performing shopping-related actions. As an additional example, each variant 500 of the landing page may be generated 330 by the online system 140 based on a set of rules describing maximum or minimum dimensions of images 520 or videos included in each variant 500, maximum or minimum font sizes of text 510 included in each variant 500, maximum or minimum volume levels of audio included in each variant 500, etc. As yet another example, the online system 140 may generate (step 330) variants 500 of the landing page for a user cohort that include a set of images 520 that were manually generated for the user cohort.

Variants 500 of the landing page generated 330 by the online system 140 also may be associated with various types of information. Examples of such types of information include: a call to action, one or more links from which the landing page may be accessed, or any other suitable types of information. For example, variants 500 of the landing page may be associated with a call to action corresponding to signing up to become a picker, signing up to create an account that allows a customer to place orders with the online system 140, etc. As an additional example, variants 500 of the landing page may be associated with an HTML button that acts as a link to the landing page. As shown in FIG. 4, once the online system 140 generates (step 330) variants 500 of the landing page for a user cohort, each variant 500 may be stored (e.g., in the data store 240). Each variant 500 may be stored in association with various types of information (e.g., information describing a user cohort for which the variant 500 was generated 330, a time the variant 500 was generated 330, a call to action associated with the variant 500, etc.).

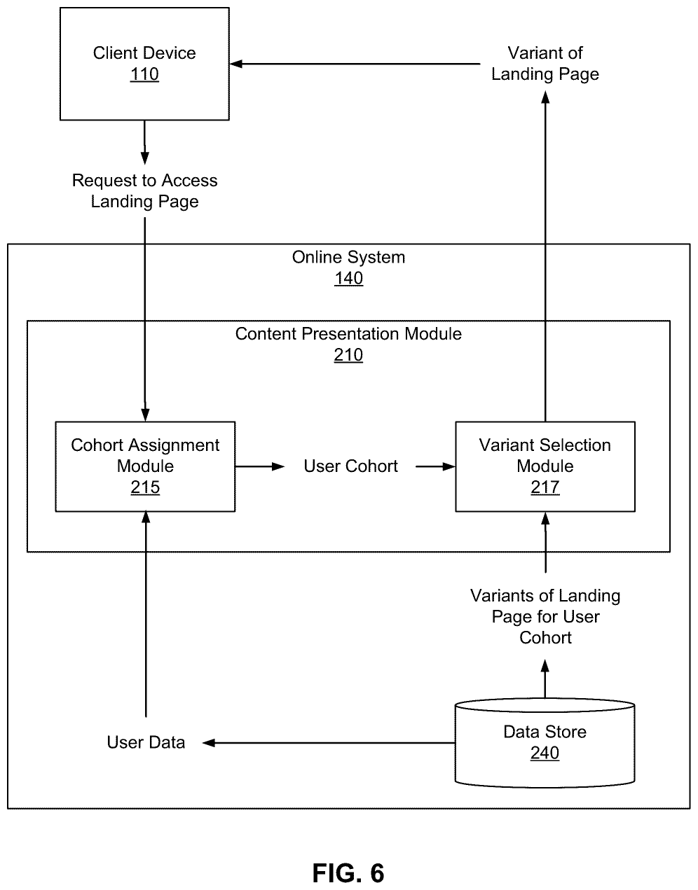

Referring again to FIG. 3, the online system 140 may then receive 335 (e.g., via the interface module 211) a request from a client device 110 associated with a user of the online system 140 to access the landing page. The online system 140 then receives 340 (e.g., by the data collection module 200 from one or more third-party systems 150) or retrieves 340 (e.g., using the cohort assignment module 215 from the data store 240) a set of user data for the user. The online system 140 assigns 345 (e.g., using the cohort assignment module 215) the user to one or more user cohorts in a manner analogous to that described above (in step 310). FIG. 6 is an interaction diagram for selecting a landing page variant 500 generated 330 for a user cohort of an online system 140, in accordance with one or more embodiments. As shown in the example of FIG. 6, the online system 140 may receive 335 the request to access the landing page from the client device 110 associated with the user. In this example, the request may be received 335 when the user interacts with an advertisement presented to the user (e.g., via a third-party system 150), in which the advertisement is associated with a call to action corresponding to learning more about becoming a picker. Continuing with this example, the online system 140 may assign 345 the user to one or more user cohorts based on the set of user data for the user. Alternatively, in the above example, if the set of user data (e.g., a set of customer data or picker data) for the user is not available or if the set of user data for the user indicates that the user has not opted in to allowing any of their personal information to be used for various purposes (e.g., selecting content for presentation to the user) with respect to one or more consumer privacy laws, policies, etc., the online system 140 may assign 345 the user to an anonymous user cohort.

Referring back to FIG. 3, the online system 140 may then retrieve 350 (e.g., using the variant selection module 217) variants 500 of the landing page generated 330 for a user cohort to which the user was assigned 345 and select 355 (e.g., using the variant selection module 217) a variant 500 to be displayed to the user. The online system 140 may select 355 the variant 500 of the landing page using one or more techniques (e.g., A/B testing, a multi-armed bandit strategy, a roulette wheel selection method, etc.) to test each variant 500. For example, to conduct an A/B test, the online system 140 may randomly select 355 the variant 500 of the landing page from multiple variants 500 of the landing page generated 330 for a user cohort to which the user was assigned 345, in which each variant 500 differs with respect to an image 520 included in the landing page. Alternatively, in the above example, the online system 140 may select 355 the variant 500 using a multi-armed bandit strategy and a roulette wheel selection method, in which each variant 500 of the landing page corresponds to an arm and arms that perform well are rewarded by being selected 355 more frequently than arms that do not perform as well. In embodiments in which the online system 140 assigns 345 the user to an anonymous user cohort, the online system 140 may retrieve 350 a default variant 500 of the landing page for display to the user, in which the default variant 500 of the landing page was generated 330 for the anonymous user cohort.

Once the online system 140 selects 355 a variant 500 of the landing page or retrieves 350 a default variant 500 of the landing page for display to the user, the online system 140 may send 360 (e.g., using the interface module 211) this variant 500 for display to the client device 110 associated with the user. For example, as shown in FIG. 6, once the online system 140 retrieves (step 350) variants 500 of the landing page generated 330 for the user cohort to which the user was assigned 345 and selects 355 the variant 500 to be displayed to the user, the online system 140 may send 360 the variant 500 for display to the client device 110 associated with the user.

Referring once more to FIG. 3, the online system 140 also may track 365 (e.g., using the variant selection module 217) the performance of each variant 500 of the landing page (e.g., based on a set of key performance indicators). For example, if the online system 140 selected 355 the variant 500 of the landing page to be displayed to the user using a multi-armed bandit strategy, the online system 140 also may track 365 the performance of the variant 500 based on a conversion rate associated with the variant 500 (e.g., a rate at which users presented with the variant 500 sign up to become pickers). In this example, variants 500 that do not perform well are eventually discarded while those that perform well may continue to be tested by ranking (e.g., using the variant selection module 217) the variants 500 based on the tracked set of key performance indicators, identifying (e.g., using the variant selection module 217) a set of variants 500 associated with at least a threshold ranking, and discarding a set of variants 500 associated with less than the threshold ranking. Information describing the performance of each variant 500 of the landing page may be stored (e.g., in the data store 240).

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

1. A method, performed at a computer system comprising a processor and a computer-readable medium, comprising:
receiving user data for a plurality of users of an online system;
assigning the plurality of users to one or more user cohorts based at least in part on the user data;
generating a prompt for content to be included in a landing page presented to each user cohort of the one or more user cohorts, wherein the prompt comprises a landing page template for the landing page and information describing the one or more user cohorts, wherein the landing page template describes types of elements for a landing page and an arrangement of those elements;
providing the prompt to a generative artificial intelligence model to obtain an output;
extracting, from the output, a set of content to be included in the landing page for each user cohort of the one or more user cohorts; and
generating, by the online system, a plurality of variants of the landing page for each user cohort of the one or more user cohorts based at least in part on the extracted set of content.

2. The method of claim 1, further comprising:
receiving a request from a client device associated with a user of the online system to access the landing page;
retrieving a set of user data for the user;
assigning the user to a user cohort of the one or more user cohorts based at least in part on the set of user data;
retrieving the plurality of variants of the landing page generated for the user cohort;
selecting a variant of the landing page from the plurality of variants of the landing page generated for the user cohort; and
sending the selected variant of the landing page for display to the client device associated with the user.

3. The method of claim 2, wherein selecting the variant of the landing page from the plurality of variants of the landing page generated for the user cohort is based at least in part on one or more of: A/B testing or a multi-armed bandit strategy.

4. The method of claim 2, wherein selecting the variant of the landing page from the plurality of variants of the landing page generated for the user cohort comprises:
tracking a set of key performance indicators associated with each variant of the plurality of variants of the landing page generated for the user cohort; and
selecting the variant of the landing page from the plurality of variants of the landing page generated for the user cohort based at least in part on the tracked set of key performance indicators.

5. The method of claim 1, further comprising:
for each user cohort of the one or more user cohorts:
tracking a set of key performance indicators associated with each variant of the plurality of variants of the landing page generated for a corresponding user cohort;
ranking the plurality of variants of the landing page generated for the corresponding user cohort based at least in part on the tracked set of key performance indicators; and
identifying a set of variants from the plurality of variants of the landing page generated for the corresponding user cohort based at least in part on the ranking.

6. The method of claim 1, wherein receiving the user data for the plurality of users comprises receiving one or more of: a set of demographic information associated with a user, a set of interests associated with a user, or a set of interactions by a user.

7. The method of claim 6, wherein the user data for the plurality of users is received from one or more of: a client device associated with a user, a third-party system, or a set of social media integrations.

8. The method of claim 6, wherein the user data comprises the set of interests associated with a user and wherein the set of interests associated with a user is associated with a set of items included among an inventory of a retailer location.

9. The method of claim 1, wherein assigning the plurality of users to the one or more user cohorts comprises:
generating an embedding representing each user of the plurality of users based at least in part on the user data; and
grouping the plurality of users into one or more clusters corresponding to the one or more user cohorts based at least in part on the embedding representing each user.

10. (canceled)

11. A computer program product comprising a non-transitory computer-readable storage medium having instructions encoded thereon that, when executed by a processor, cause the processor to perform steps comprising:
receiving user data for a plurality of users of an online system;
assigning the plurality of users to one or more user cohorts based at least in part on the user data;
generating a prompt for content to be included in a landing page presented to each user cohort of the one or more user cohorts, wherein the prompt comprises a landing page template for the landing page and information describing the one or more user cohorts, wherein the landing page template describes types of elements for a landing page and an arrangement of those elements;
providing the prompt to a generative artificial intelligence model to obtain an output;
extracting, from the output, a set of content to be included in the landing page for each user cohort of the one or more user cohorts; and
generating, by the online system, a plurality of variants of the landing page for each user cohort of the one or more user cohorts based at least in part on the extracted set of content.

12. The computer program product of claim 11, wherein the computer-readable storage medium further has instructions encoded thereon that, when executed by the processor, cause the processor to perform steps comprising:
receiving a request from a client device associated with a user of the online system to access the landing page;
retrieving a set of user data for the user;
assigning the user to a user cohort of the one or more user cohorts based at least in part on the set of user data;
retrieving the plurality of variants of the landing page generated for the user cohort;
selecting a variant of the landing page from the plurality of variants of the landing page generated for the user cohort; and
sending the selected variant of the landing page for display to the client device associated with the user.

13. The computer program product of claim 12, wherein select the variant of the landing page from the plurality of variants of the landing page generated for the user cohort is based at least in part on one or more of: A/B testing or a multi-armed bandit strategy.

14. The computer program product of claim 12, wherein selecting the variant of the landing page from the plurality of variants of the landing page generated for the user cohort comprises:
tracking a set of key performance indicators associated with each variant of the plurality of variants of the landing page generated for the user cohort; and
selecting the variant of the landing page from the plurality of variants of the landing page generated for the user cohort based at least in part on the tracked set of key performance indicators.

15. The computer program product of claim 11, wherein the computer-readable storage medium further has instructions encoded thereon that, when executed by the processor, cause the processor to perform steps comprising:
for each user cohort of the one or more user cohorts:
tracking a set of key performance indicators associated with each variant of the plurality of variants of the landing page generated for a corresponding user cohort;
ranking the plurality of variants of the landing page generated for the corresponding user cohort based at least in part on the tracked set of key performance indicators; and
identifying a set of variants from the plurality of variants of the landing page generated for the corresponding user cohort based at least in part on the ranking.

16. The computer program product of claim 11, wherein receiving the user data for the plurality of users comprises receiving one or more of: a set of demographic information associated with a user, a set of interests associated with a user, or a set of interactions by a user.

17. The computer program product of claim 16, wherein the user data for the plurality of users is received from one or more of: a client device associated with a user, a third-party system, or a set of social media integrations.

18. The computer program product of claim 16, wherein the user data comprises the set of interests associated with a user and wherein the set of interests associated with a user is associated with a set of items included among an inventory of a retailer location.

19. The computer program product of claim 11, wherein assigning the plurality of users to the one or more user cohorts comprises:
generating an embedding representing each user of the plurality of users based at least in part on the user data; and
grouping the plurality of users into one or more clusters corresponding to the one or more user cohorts based at least in part on the embedding representing each user.

20. A computer system comprising:
a processor; and
a non-transitory computer-readable storage medium storing instructions that, when executed by the processor, perform actions comprising:
receiving user data for a plurality of users of an online system;
assigning the plurality of users to one or more user cohorts based at least in part on the user data;
generating a prompt for content to be included in a landing page presented to each user cohort of the one or more user cohorts, wherein the prompt comprises a landing page template for the landing page and information describing the one or more user cohorts, wherein the landing page template describes types of elements for a landing page and an arrangement of those elements;
providing the prompt to a generative artificial intelligence model to obtain an output;
extracting, from the output, a set of content to be included in the landing page for each user cohort of the one or more user cohorts; and
generating, by the online system, a plurality of variants of the landing page for each user cohort of the one or more user cohorts based at least in part on the extracted set of content.
